(19) United States
(12) Patent Application Publication
(10) Pub. No.: US 2011/0034330 A1
(43) Pub. Date: Feb. 10, 2011

(54) COATED CATALYSTS COMPRISING A MULTIMETAL OXIDE COMPRISING MOLYBDENUM, BISMUTH AND IRON

(75) Inventors: Alexander Czaja, Dirmstein (DE); Martin Kraus, Westfield, NJ (US)

Correspondence Address: CONNOLLY BOVE LODGE & HUTZ LLP, P.O. BOX 2207, WILMINGTON, DE, 19899, US

(73) Assignee: BASF SE, Ludwigshafen (DE)

(21) Appl. No.: 12/937,219

(22) PCT Filed: Apr. 7, 2009
(86) PCT No.: PCT/EP09/54167

§ 371 Date: Oct. 8, 2010

(30) Foreign Application Priority Data
Apr. 9, 2008 (EP) 08154235.9

(51) Int. Cl. B01J 23/881; B01J 21/06

(52) U.S. Cl. 502/243; 502/311

(57) ABSTRACT

The invention relates to a coated catalyst, which is obtainable from a catalyst precursor comprising

(a) a support body,

(b) a coating comprising (i) a catalytically active, multimetal oxide which comprises molybdenum and at least one further metal and is of the general formula (I)

Mo₁₂BiₐCr_{b}X¹_{c}Fe_{d}X²ₑX³_{f}O_{y} (I)
where
X¹=Co and/or Ni,
X²=Si and/or Al,
X³=Li, Na, K, Cs and/or Rb,
0.2≦a≦1,
0≦b≦2,
2≦c≦10,
0.5≦d≦10,
0≦e≦10,
0≦f≦0.5 and
y=a number which, with the prerequisite of charge neutrality, is determined by the valency and frequency of the elements in (I) other than oxygen, and (ii) at least one pore former.

The invention relates to coated catalysts comprising a catalytically active multimetal oxide comprising molybdenum, bismuth and iron.

Processes for preparing coated catalysts based on molybdenum-comprising multimetal oxides are known, for example, from WO 95/11081, WO 2004/108267, WO 2004/108284, US-A 2006/0205978, EP-A 714700 and DE-A 102005010645. The active composition in this case is a multimetal oxide comprising molybdenum and vanadium or one comprising molybdenum, bismuth and iron. The term “multimetal oxide” expresses the fact that the active composition, as well as molybdenum and oxygen, also comprises at least one further chemical element.

Catalysts of the aforementioned type are described for the catalysis of the heterogeneously catalyzed partial gas phase oxidation of acrolein to acrylic acid, of propene to acrolein, and of tert-butanol, isobutane, isobutene or tert-butyl methyl ether to methacrolein.

EP-A 0 714 700 describes the preparation of coated catalysts based on multimetal oxide compositions comprising Mo and V for the gas phase oxidation of acrolein to acrylic acid, and also of coated catalysts based on multimetal oxide compositions comprising Mo, Bi and Fe for the gas phase oxidation of propene to acrolein and of tert-butanol, isobutane, isobutene or tert-butyl methyl ether to methacrolein.

US 2006/0205978 describes a coated catalyst having an active composition Mo₁₂W_{0.5}Co₅Ni₃Bi_{1.3}Fe_{0.8}Si₂K_{0.08}Oₓ for the oxidation of propene to acrolein and acrylic acid.

EP-A 0 630 879 describes a process for catalytic oxidation of propene, isobutene or tert-butanol over a multimetal oxide catalyst comprising molybdenum, bismuth and iron, which works in the presence of a molybdenum oxide, which is essentially catalytically inactive. The presence of the molybdenum oxide inhibits the deactivation of the multimetal oxide catalyst.

It is an object of the invention to provide catalysts based on multimetal oxides comprising molybdenum, bismuth and iron for the oxidative dehydrogenation of butenes to butadiene, which have a high activity and selectivity.

The object is achieved by a coated catalyst which is obtainable from a catalyst precursor comprising

(a) a support body,

(b) a coating comprising (i) a catalytically active, multimetal oxide which comprises molybdenum and at least one further metal and is of the general formula (I)

Mo₁₂BiₐCr_{b}X¹_{c}Fe_{d}X²ₑX³_{f}O_{y} (I)
where
X¹=Co and/or Ni,
X²=Si and/or Al,
X³=Li, Na, K, Cs and/or Rb,
0.2≦a≦1,
0≦b≦2,
2≦c≦10,
0.5≦d≦10,
0≦e≦10,
0≦f≦0.5 and
y=a number which, with the prerequisite of charge neutrality, is determined by the valency and frequency of the elements in (I) other than oxygen, and (ii) at least one pore former.

The object is also achieved by a process for preparing the coated catalyst, in which a layer comprising (i) a catalytically active multimetal oxide comprising molybdenum and at least one further metal, and (ii) a pore former, is applied to a support body by means of a binder, and the coated support body is dried and calcined.

The object is also achieved by the use of the inventive coated catalysts in processes for catalytic gas phase oxidation of organic compounds.

Preference is given to those coated catalysts whose catalytically active oxide composition comprises only Co as X¹. Preferred X² is Si and X³ is preferably K, Na and/or Cs, more preferably X³=K.

The stoichiometric coefficient a is preferably 0.4≦a≦1, more preferably 0.4≦a≦0.95. The stoichiometric coefficient b is preferably in the range of 0.1≦b≦2, and more preferably in the range of 0.2≦b≦1. The stoichiometric coefficient c is preferably in the range of 4≦c≦8, and more preferably in the range of 6≦c≦8. The value for the variable d is advantageously in the range of 1≦d≦5 and particularly advantageously in the range of 2≦d≦4. The stoichiometric coefficient f is appropriately ≧0. Preferably, 0.01≦f≦0.5 and, more preferably, 0.05≦f≦0.2.

The value of the stoichiometric coefficient of oxygen, y, arises from the valency and frequency of the cations with the prerequisite of charge neutrality. Favorable inventive coated catalysts are those with catalytically active oxide compositions whose molar ratio of Co/Ni is at least 2:1, preferably at least 3:1 and more preferably at least 4:1. At best only Co is present.

Such molybdenum-comprising multimetal oxides are suitable not only for the selective gas phase oxidation of propene to acrolein, but also for the partial gas phase oxidation of other alkenes, alkanes, alkanones or alkanols to alpha,beta-unsaturated aldehydes and/or carboxylic acids. Examples include the preparation of methacrolein and methacrylic acid from isobutene, isobutane, tert-butanol or tert-butyl methyl ether.

Preferred gas phase oxidations for which the inventive coated catalysts are used are oxidative dehydrogenations of alkenes to 1,3-dienes, especially of 1-butene and/or 2-butene to 1,3-butadiene.

The layer of the coated catalyst comprising the multimetal oxide comprises a pore former. Suitable pore formers are, for example, malonic acid, melamine, nonylphenol ethoxylate, stearic acid, glucose, starch, fumaric acid and succinic acid.

Preferred pore formers are stearic acid, nonylphenol ethoxylate and melamine.

Finely divided Mo-comprising multimetal oxides for use in accordance with the invention are in principle obtainable by obtaining an intimate dry mixture from starting compounds of the elemental constituents of the catalytically active oxide composition and thermally treating the intimate dry mixture at a temperature of from 150 to 350° C.

For the preparation of suitable finely divided multimetal oxide compositions of this type and other types, the starting materials are known starting compounds of the elemental constituents of the desired multimetal oxide composition other than oxygen in the particular stoichiometric ratio, and these are used to obtain a very intimate, preferably finely divided dry mixture which is then subjected to the thermal treatment. The sources may either already be oxides or be those compounds which can be converted to oxides by heating, at least in the presence of oxygen. In addition to the oxides, useful starting compounds are therefore in particular halides, nitrates, formates, oxalates, acetates, carbonates or hydroxides.

Suitable starting compounds of Mo are also the oxo compounds thereof (molybdates) or the acids derived therefrom.

Suitable starting compounds of Bi, Cr, Fe and Co are especially the nitrates thereof.

The intimate mixing of the starting compounds can in principle be effected in dry form or in the form of aqueous solutions or suspensions.

Preference is given to effecting the intimate mixing in the form of an aqueous solution and/or suspension. Particularly intimate dry mixtures are obtained in the mixing process described when the starting materials are exclusively sources and starting compounds present in dissolved form. The solvent used is preferably water. Subsequently, the aqueous composition (solution or suspension) is dried and the intimate dry mixture thus obtained is, if appropriate, thermally treated directly. Preference is given to effecting the drying process by spray-drying (the exit temperatures are generally from 100 to 150° C.) and immediately after the completion of the aqueous solution or suspension.

Optionally, if the powder obtained is found to be too finely divided for direct further processing, it can be kneaded with addition of water. In many cases, an addition of a lower organic carboxylic acid (e.g. acetic acid) is found to be advantageous in the case of kneading. Typical added amounts are from 5 to 10% by weight, based on powder composition used. The kneaded material obtained is subsequently appropriately shaped to extrudates, which are treated thermally as already described and then ground to a fine powder.

Support materials suitable for coated catalysts obtainable in accordance with the invention are, for example, porous or preferably nonporous aluminum oxides, silicon dioxide, zirconium dioxide, silicon carbide or silicates such as magnesium or aluminum silicate (e.g. C 220 steatite from CeramTec). The materials of the support bodies are chemically inert.

The support bodies may be of regular or irregular shape, preference being given to regular-shaped support bodies with distinct surface roughness, for example spheres, cylinders or hollow cylinders with a grit layer. Their longest dimension is generally from 1 to 10 mm.

The support materials may be porous or nonporous. The support material is preferably nonporous (total volume of the pores based on the volume of the support body preferably ≦1% by volume). An increased surface roughness of the support body generally causes an increased adhesive strength of the applied coating composed of first and second layers.

The surface roughness R_{Z} of the support body is preferably in the range from 30 to 100 μm, preferably from 50 to 70 μm (determined to DIN 4768 sheet 1 with a “Hommel tester for DIN-ISO surface parameters” from Hommelwerke). Particular preference is given to rough-surface support bodies from CeramTec composed of C 220 steatite.

Particularly suitable in accordance with the invention is the use of essentially nonporous, rough-surface, spherical supports composed of steatite (e.g. C 220 steatite from CeramTec), whose diameter is from 1 to 8 mm, preferably from 2 to 6 mm, more preferably from 2 to 3 or from 4 to 5 mm. Also suitable, however, is the use of cylinders as support bodies, whose length is from 2 to 10 mm and whose external diameter is from 4 to 10 mm. In the case of rings as support bodies, the wall thickness is additionally typically from 1 to 4 mm. Annular support bodies for use with preference have a length of from 2 to 6 mm, an external diameter of from 4 to 8 mm and a wall thickness of from 1 to 2 mm. Also suitable are in particular rings of geometry 7 mm×3 mm×4 mm (external diameter×length×internal diameter) as support bodies.

The layer thickness T composed of a molybdenum-comprising multimetal oxide composition (i) and the pore former (ii) is generally from 5 to 1000 μm. Preference is given to from 10 to 500 μm, particular preference to from 20 to 250 μm and very particular preference to from 30 to 200 μm.

The granularity (fineness) of the Mo-comprising finely divided multimetal oxide is adjusted to the desired layer thickness T in the same manner as the granularity of the molybdenum oxide or of the precursor compound. All statements made with regard to the longest dimension d_{L} of the molybdenum oxide or of the precursor compound therefore apply correspondingly to the longest dimension d_{L} of the finely divided Mo-comprising multimetal oxide.

The finely divided compositions (molybdenum-comprising multimetal oxide (i) and pore former (ii)) can be applied to the surface of the support body according to the processes described in the prior art, for example as described in US-A 2006/0205978 and EP-A 0 714 700.

In general, the finely divided compositions are applied to the surface of the support body or to the surface of the first layer with the aid of a liquid binder. Useful liquid binders include, for example, water, an organic solvent or a solution of an organic substance (for example of an organic solvent) in water or in an organic solvent.

Examples of organic binders include mono- or polyhydric organic alcohols, for example ethylene glycol, 1,4-butanediol, 1,6-hexanediol or glycerol, mono- or polybasic organic carboxylic acids such as propionic acid, oxalic acid, malonic acid, glutaric acid or maleic acid, amino alcohols such as ethanolamine or diethanolamine, and mono- or polyfunctional organic amides such as formamide. Suitable organic binder promoters soluble in water, in an organic liquid or in a mixture of water and an organic liquid are, for example, monosaccharides and oligosaccharides such as glucose, fructose, sucrose and/or lactose. Particularly advantageously, the liquid binder used is a solution consisting of from 20 to 95% by weight of water and from 5 to 80% by weight of an organic compound. The organic content in the aforementioned liquid binders is preferably from 10 to 50% by weight and more preferably from 10 to 30% by weight.

Preference is generally given to those organic binders or binder fractions whose boiling point or sublimation temperature at standard pressure (1 atm) is ≧100° C., preferably ≧150° C. Most preferably, the boiling point or sublimation point of such organic binders or binder fractions at standard pressure is simultaneously below the highest calcination temperature employed in the course of preparation of the finely divided multimetal oxide comprising the element Mo. Typically, this highest calcination temperature is ≦600° C., frequently ≦500° C. or ≦400° C., in many cases even ≦300° C.

Particularly preferred liquid binders are solutions which consist of from 20 to 95% by weight of water and from 5 to 80% by weight of glycerol. The glycerol content in these aqueous solutions is preferably from 5 to 50% by weight and more preferably from 5 to 25% by weight.

The molybdenum oxide or the precursor compound (ii) and/or the Mo-comprising finely divided multimetal oxide (i) can be applied in such a way that the finely divided composition composed of molybdenum oxide or of the precursor compound (ii), of the Mo-comprising finely divided multimetal oxide (i) or a mixture thereof and (if appropriate) the pore former (iii) are dispersed in the liquid binder and the resulting suspension is sprayed onto moving and, if appropriate, hot support bodies, as described in DE-A 1642921, DE-A 2106796 and DE-A 2626887. After the spray application has ended, as described in DE-A 2909670, the moisture content of the resulting coated catalysts can be reduced by passing hot air over.

However, the support bodies will preferably first be moistened with the liquid binder and then the finely divided composition (multimetal oxide (i) and pore former (ii)) will be applied to the surface of the support body moistened with binder by rolling the moistened support bodies in the finely divided composition. To achieve the desired layer thickness, the above-described process is preferably repeated several times, i.e. the base-coated support body is in turn moistened and then coated by contact with dry finely divided composition.

In general, the coated support body is calcined at a temperature of from 150 to 600° C., preferably from 270 to 500° C. The calcination time is generally from 2 to 24 h, preferably from 5 to 20 h. The calcination is performed in an oxygenous atmosphere, preferably air. In one embodiment of the invention, the calcination is effected according to a temperature program in which calcination is effected for a total of from 2 to 10 h at temperatures between 150 and 350° C., preferably from 200 to 300° C., and at temperatures between 350 and 550° C., preferably from 400 to 500° C.

The pore former (iii) may be present in the finely divided composition or be added to the liquid binder. Pore formers are generally present in amounts of from 1 to 40% by weight, preferably from 5 to 20% by weight, in the compositions applied to the support body, the data being based on the sum of multimetal oxide (i), pore former (ii) and binder.

For a performance of the process according to the invention on the industrial scale, it is advisable to employ the process disclosed in DE-A 2909671, but preferably using the binders recommended in EP-A 714700. In other words, the support bodies to be coated are charged into a preferably tilted (the tilt angle is generally from 30 to 90°) rotating vessel (for example rotary pan or coating tank). The rotating vessel conducts the especially spherical, cylindrical or hollow cylindrical support bodies under two metering devices arranged in succession at a particular distance. The first of the two metering devices is appropriately a nozzle through which the support bodies rolling in the rotating pan are sprayed with the liquid binder to be used and moistened in a controlled manner. The second metering device is disposed outside the atomization cone of the liquid binder sprayed in and serves to supply the finely divided composition, for example by means of a shaking channel. The support spheres moistened in a controlled manner take up the active composition powder supplied, which is compacted by the rolling motion on the outer surface of the cylindrical or spherical support bodies to give a cohesive coating.

If required, the thus base-coated support body, in the course of the subsequent rotation, again passes through the spray nozzle, and is moistened in a controlled manner, in order to be able to take up a further layer of finely divided composition in the course of further movement, etc. Intermediate drying is generally not required. The liquid binder used in accordance with the invention can be removed, partly or fully, by final supply of heat, for example, by the action of hot gases, such as N₂ or air. A particular advantage of the above-described embodiment of the process according to the invention consists in the fact that, in one procedure, coated catalysts with coatings consisting of two or more different compositions in layer form can be prepared. Remarkably, the process according to the invention brings about both completely satisfactory adhesion of the successive layers to one another and of the base layer on the surface of the support body. This is also true in the case of annular support bodies.

The object is also achieved by the use of the inventive coated catalysts in processes for catalytic gas phase oxidation of organic compounds.

The layer of catalytically active multimetal oxide and pore former may additionally comprise a molybdenum oxide or a precursor compound which forms molybdenum oxide. This can, as described in theoretical terms in EP-A 0 630 879, counteract deactivation of the catalyst. The precursor compound is a compound of molybdenum from which, under the action of elevated temperature and in the presence of molecular oxygen, an oxide of molybdenum forms. The action of the elevated temperature and of the molecular oxygen can proceed after the application of the precursor compound to the surface of the support body. To this end, a thermal treatment can be effected, for example, under an oxygen or air atmosphere. The precursor compound can also be converted to an oxide of the molybdenum by the action of heat and oxygen only during the use of the catalyst in the catalytic gas phase oxidation.

Examples of suitable precursor compounds other than an oxide of molybdenum include ammonium molybdate [(NH₄)₂MoO₄] and ammonium polymolybdates such as ammonium heptamolybdate tetrahydrate [(NH₄)₆Mo₇O₂₄·4 H₂O]. A further example is molybdenum oxide hydrate (MoO₃˜xH₂O). However, molybdenum hydroxides are also useful as such precursor compounds. However, the layer preferably already comprises an oxide of molybdenum. A particularly preferred molybdenum oxide is molybdenum trioxide (MoO₃). Further suitable molybdenum oxides are, for example, Mo₁₈O₅₂, Mo₈O₂₃ and Mo₄O₁₁ (cf., for example, Surface Science 292 (1993) 261-6, or J. Solid State Chem. 124 (1996) 104).

Molybdenum oxide and catalytically active, molybdenum-comprising multimetal oxide (I) may also be present in separate layers. For instance, the coated catalyst may also be formed from (a) a support body, (b) a first layer comprising molybdenum oxide or a precursor compound which forms molybdenum oxide, and (c) a second layer comprising the molybdenum-comprising catalytically active multimetal oxide of the formula (I) and the pore former. It is possible to prepare such a coated catalyst, by applying to the support body, by means of a binder, a first layer of a molybdenum oxide or of a precursor compound which forms molybdenum oxide, if appropriate drying and calcining the support body coated with the first layer, and applying to the first layer, by means of a binder, a second layer of a molybdenum-comprising multimetal oxide, and drying and calcining the support body coated with the first and second layer.

It is also possible to use the inventive coated catalyst in a mixture with separate shaped bodies comprising a molybdenum oxide, or to provide a separate bed of shaped bodies comprising molybdenum oxide, in order to counteract the deactivation of the catalyst.

The present invention also provides for the use of the inventive coated catalysts in processes for gas phase oxidation, preferably in processes for oxidative dehydrogenation of olefins to dienes, especially of 1-butene and/or 2-butene to butadiene. The inventive catalysts are notable for a high activity, but especially also for a high selectivity based on the formation of 1,3-butadiene from 1-butene and 2-butene.

The invention is illustrated in detail by the examples which follow.

### EXAMPLES

### Example 1

### Preparation of a Precursor Composition A or of an Unsupported Catalyst U1 of Stoichiometry Mo₁₂Co₇Fe₃K_{0.08}Bi_{0.6}Cr_{0.5}

Solution A:

A 10 l stainless steel vessel was initially charged with 3200 g of water. With stirring by means of an anchor stirrer, 4.9 g of a KOH solution (32% by weight of KOH) were then added to the initially charged water. The solution was heated to 60° C. 1066 g of an ammonium heptamolybdate solution ((NH₄)₆Mo₇O₂₄*4 H₂O, 54% by weight of Mo) were then added in portions over a period of 10 minutes. The resulting suspension was stirred for a further 10 minutes.

Solution B:

A 5 l stainless steel vessel was initially charged with 1663 g of a cobalt(II) nitrate solution (12.4% by weight of Co) and heated to 60° C. with stirring (anchor stirrer). 616 g of an iron(III) nitrate solution (13.6% by weight of Fe) were then added in portions over a period of 10 minutes while maintaining the temperature. The resulting solution was stirred for a further 10 min. 575 g of a bismuth nitrate solution (10.9% by weight of Bi) were then added while maintaining the temperature. After continuing to stir for a further 10 minutes, 102 g of chromium(III) nitrate were added in portions in solid form and the resulting dark red solution was stirred for a further 10 min.

Precipitation:

While maintaining the 60° C., solution B was pumped into solution A by means of a peristaltic pump within 15 min. During the addition and thereafter, the mixture was stirred by means of an intensive mixer (Ultra-Turrax). On completion of addition, the mixture was stirred for another 5 min.

Spray-drying:

The resulting suspension was spray-dried in a spray tower from NIRO (spray head No. F0 A1, speed 25 000 rpm) over a period of 1.5 h. The reservoir temperature was kept at 60° C. The gas input temperature of the spray tower was 300° C., the gas output temperature 110° C. The resulting powder had a particle size (d₉₀) of less than 40 μm.

### Example 2

### Preparation of an Unsupported Catalyst

Shaping (unsupported catalyst):

The resulting powder was mixed with 1% by weight of graphite, compacted twice with pressure 9 bar and comminuted through a screen with mesh size 0.8 mm. The spall was, in turn, mixed with 2% by weight of graphite and the mixture was pressed with a Kilian S100 tableting press into 5×3×2 mm rings.

Calcination (unsupported catalyst):

The resulting powder was calcined batchwise (500 g) in a forced-air oven from Heraeus, Germany (model K, 750/2 S, capacity 55 l) at 460° C.

On completion of calcination and after cooling, 290 g of catalyst U1 were obtained. This step completes the preparation of the unsupported catalyst.

Calcination (coated catalyst):

The resulting powder was calcined batchwise (500 g) in a covered porcelain dish in a forced-air oven (500 l (STP)/h) at 460° C.

On completion of calcination and after cooling, 296 g of light brown powder (precursor composition A) were obtained.

### Example 3

### Preparation of a Comparative Coated Catalyst CC1

49.5 g of precursor composition A were applied to 424 g of support bodies (steatite spheres of diameter 2-3 mm with grit layer). To this end, the support was initially charged in a coating drum (capacity 21, angle of inclination of the central drum axis relative to the horizontal=30°). The drum was set in rotation (25 rpm). An atomizer nozzle operated with compressed air was used to spray approx. 32 ml of liquid binder (10:1 glycerol:water mixture) onto the support over the course of approx. 30 min (spraying air 500 l (STP)/h).

The nozzle was installed such that the spray cone wetted the support bodies conveyed within the drum in the upper half of the roll-off zone. The fine pulverulent precursor composition A was introduced into the drum by means of a powder screw, and the point of powder addition was within the roll-off zone, but below the spray cone. The powder addition was metered in in such a way as to give rise to homogeneous distribution of the powder on the surface. On completion of the coating, the resulting coated catalyst composed of precursor composition A and the support body was dried in a drying cabinet at 120° C. for 2 hours.

Thereafter, the coated catalyst was calcined in a forced-air oven from Heraeus, Germany (model K, 750/2 S, capacity 55 l) at 455° C.

### Example 4

### Preparation of an Inventive Coated Catalyst C (Pore Former: Malonic Acid)

49.5 g of precursor composition A were mixed intimately with 9.9 g of malonic acid. The resulting powder was applied according to the procedure for CC1 to 424 g of support bodies (Ceramtec rough steatite spheres of diameter 2-3 mm with grit layer). Otherwise, the procedure was as for the preparation of CC1.

### Example 5

### Preparation of an Inventive Coated Catalyst C1 (Pore Former: Nonylphenol Ethoxylate)

According to the procedure for CC1, 49.5 g of precursor composition A were applied to 424 g of support bodies (steatite spheres of diameter 2-3 mm with grit layer). In a departure from the method described under CC1, the pore former (4.95 g of nonylphenol ethoxylate, BASF Lutensol AP6) had to be dissolved in the binder (approx. 32 ml in total) and was not mixed with the precursor composition A, since it was a liquid product.

### Example 6

### Preparation of an Inventive Coated Catalyst C2 (Pore Former: Melamine)

49.5 g of precursor composition A were mixed intimately with 4.95 g of melamine. The resulting powder was applied according to the procedure for CC1 to 424 g of support bodies (Ceramtec rough steatite spheres of diameter 2-3 mm with grit layer). Otherwise, the procedure was as for the preparation of CC1.

### Example 7

### Testing of the Catalysts

The coated catalysts were each used to charge a reaction tube made of V2A steel (external diameter=21 mm, internal diameter=15 mm). The charge length was set to 78-80 cm in all cases.

The temperature of the reaction tube was controlled over its entire length with a salt bath which flowed around it. As the starting reaction gas mixture a mixture of 9.7% by volume of butane, 6.4% by volume of 1-, cis-2- and trans-2-butenes together, 9.6% by volume of oxygen, 4.3% by volume of hydrogen, 57.1% by volume of nitrogen and 12.9% by volume of water was employed. The loading of the reaction tube was varied between 120 l (STP)/h, 180 l (STP)/h and 240 l (STP)/h. The salt bath temperature was constant at 390° C.

In the product gas stream, the selectivity S of product of value formation of 1,3-butadiene and the conversion C of the reactant mixture of butenes were determined by gas chromatography analysis.

C and S are defined as follows:

C (mol %)=(number of moles of butenes in the starting mixture−number of moles of butenes in the product mixture)/(number of moles of butenes in the starting mixture)×100

S (mol %)=(number of moles of 1,3-butadiene in the product mixture)/(number of moles of butenes in the starting mixture−number of moles of butenes in the product mixture)×100

The results are compiled in the table which follows.

| Catalyst | 120 l (STP)/h (c/S) | 180 l (STP)/h (c/S) | 240 l (STP)/h (C/S) |
|---|---|---|---|
| CC1 | 94.8%/82.7% | 93.5%/89.2% | 90.0%/90.7% |
| c | 92.3%/90.0% | 89.5%/92.8% | 86.0%/96.0% |
| U1 | 96.5%/80.1% | 94.3%/82.9% | 91.7%/88.0% |
| | | 94.2%/85.2% | |
| C1 | 96.0%/85.4% | 93.5%/94.4% | 85.2%/100% |
| C2 | 95.0%/89.0% | 91.2%/97.7% | 86.3%/100% |

1.-5. (canceled)

6. A coated catalyst which is obtainable from a catalyst precursor comprising
(a) a support body,
(b) a coating comprising (i) a catalytically active, multimetal oxide which comprises molybdenum and at least one further metal and is of the general formula (I)
Mo₁₂BiₐCr_{b}X¹_{c}Fe_{d}X²ₑX³_{f}O_{y} (I)
where
X¹=Co and/or Ni,
X²=Si and/or Al,
X³=Li, Na, K, Cs and/or Rb,
0.2≦a≦1,
0≦b≦2,
2≦c≦10,
0.5≦d≦10,
0≦e≦10,
0≦f≦0.5 and
y=a number which, with the prerequisite of charge neutrality, is determined by the valency and frequency of the elements in (I) other than oxygen, and (ii) at least one pore former.

7. The coated catalyst according to claim 1, wherein the coating comprising the catalytically active multimetal oxide (i) and the pore former (ii) additionally comprises (iii) a molybdenum oxide or a precursor compound, which forms molybdenum oxide.

8. A process for preparing the coated catalyst according to claim 1, in which a layer comprising (i) a catalytically active multimetal oxide comprising molybdenum and at least one further metal, and (ii) a pore former, are applied to a support body by means of a binder, and the coated support body is dried and calcined.
